(19) United States
(12) Patent Application Publication
(10) Pub. No.: US 2009/0287322 A1
(43) Pub. Date: Nov. 19, 2009

(54) INSTRUMENTATION CONTROL SYSTEM

(75) Inventors: Masahito ENDO, Musashino-shi (JP); Hiroshi Miyata, Musashino-shi (JP); Yukiyo Akisada, Musashino-shi (JP); Hiroki Endo, Musashino-shi (JP); Kensuke Hosoya, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 12/436,479

(22) Filed: May 6, 2009

(30) Foreign Application Priority Data
May 15, 2008 (JP) 2008-127899

(51) Int. Cl. G05B 9/02

(52) U.S. Cl. 700/81; 700/67; 700/11

(57) ABSTRACT

Disclosed is an instrumentation control system, including: a first field device; and a second field device coupled to the first field device via a fieldbus. The first field device includes: a transmitting buffer to store data to be transmitted; a transmitter; and an inquiry processing section to cause the transmitter to retransmit the data stored in the transmitting buffer to the second field device in response to a request from the second field device. The second field device includes: a receiving buffer to store the data transmitted from the first field device; a checking section to determine whether the data stored in the receiving buffer is normal or not, and to make a data retransmission request to the first field device if the data stored in the receiving buffer is not normal; and a processing unit to perform predetermined processing based on the data which is determined to be normal.

### BACKGROUND OF THE INVENTION

1. Field of the Invention

The present invention relates to an instrumentation control system utilizing a fieldbus communication method.

2. Description of Related Art

An instrumentation control system has been proposed. In the instrumentation control system, measurement data acquired by various measuring instruments is transmitted to a control device through a network and the control device automatically performs a necessary control operation (for example, a process of controlling a predetermined actuator) on the basis of the measurement data in a production facility or a large plant.

In recent years, an instrumentation control system has been proposed which performs communication between a measuring device and a control device using a digital bidirectional fieldbus communication method, instead of an analog communication method (for example, see Japanese Patent Application Laid-Open Nos. 6-284477, 11-120031, 2007-128436, and 2006-262130).

In the following description, the instrumentation control system using the fieldbus communication method is referred to as a field network system, and a measuring instrument (for example, a sensor such as a flow meter) and an operation terminal (for example, an actuator such as a motor, an electromagnet valve, a fan, a pump, or a valve) corresponding to the fieldbus communication method are referred to as field devices.

In the field network system, the field device can have a control device function (control function). Therefore, bidirectional communication between the field devices makes it possible to improve the convenience of an operation. For example, an actuator having a control function can automatically perform its own process on the basis of measurement data transmitted from a measuring instrument.

The field devices of the field network system will be briefly described below.

FIG. 8 is a block diagram showing a schematic configuration of a first field device 1 as a measuring instrument. FIG. 9 is a block diagram showing a schematic configuration of a second field device 2 as an actuator.

As shown in FIG. 8, the first field device 1 includes a control unit 11 that performs overall control of each part, a sensor 13 that acquires measurement data, and a communication unit 12 that transmits the measurement data to the second field device 2. The communication unit 12 includes a transmitting buffer 121 that temporarily stores the measurement data, and a transmitter 122 that periodically transmits the measurement data stored in the transmitting buffer 121 to the second field device 2.

As shown in FIG. 9, the second field device 2 includes a control unit 21 that performs overall control of each part, a communication unit 22 that receives the measurement data transmitted from the first field device 1, and a processing unit 23 that performs predetermined processing on the basis of the received measurement data. The communication unit 22 includes a receiver 222 that receives the measurement data transmitted from the first field device 1 and a receiving buffer 221 that temporarily stores the measurement data received by the receiver 222.

The first field device 1 shown in FIG. 8 and the second field device 2 shown in FIG. 9 can communicate with each other through a network (fieldbus) In the field network system, the first field device 1 transmits the acquired measurement data to the second field device 2, and the second field device 2 performs predetermined processing on the basis of the measurement data transmitted from the first field device 1.

FIG. 10 is a sequence chart illustrating sequence control in the conventional field network system. Suppose that the time at which the sensor 13 acquires measurement data and the time at which the transmitter 122 performs data transmission are set in advance. Similarly, suppose that the time at which the processing unit 23 performs control processing is set in advance. In addition, suppose that a destination address of the measurement data is set to an address of the second field device 2 in advance.

As shown in FIG. 10, in the first field device 1, the sensor 13 periodically acquires measurement data, and the acquired measurement data is stored in the transmitting buffer 121 (Step S501). Then, the measurement data stored in the transmitting buffer 121 is periodically transferred to the transmitter 122 (Step S502), and the transmitter 122 transmits the measurement data to the second field device 2 (Step S503).

In the second field device 2, the receiver 222 receives the measurement data transmitted from the first field device 1 (Step S503), and the received measurement data is stored in the receiving buffer 221 (Step S504). Then, the measurement data stored in the receiving buffer 221 is periodically transferred to the processing unit 23, and the processing unit 23 performs processing on the basis of the measurement data (Step S505).

Since the second field device 2 having a control function periodically performs predetermined processing on the basis of the measurement data transmitted from the first field device 1, it is possible to improve the convenience of an operation.

A currently widespread field network system is constructed in a plant facility in isolation, and a protocol unique to a manufacturer is used for communication. Such a field network system will require scalability and flexibility in the future.

An IP (Internet protocol) has drawn attention as a technique for satisfying the requirements. The IP has already been used for the field network system. The use of IP makes it possible to overlap communication used for instrumentation control with communication used for the Internet, such as a web or a mail, on a single communication medium. Thus, the cost of a communication medium, such as a cable, can be reduced.

The IP, however, does not have a structure for guaranteeing communication data. Therefore, when traffic is increased due to overlapped communication, communication data is likely to be missed, for example. In the field network system, if an actuator does not normally receive measurement data transmitted from a measuring instrument, it is difficult for the actuator to perform a desired process. As a result, an unexpected error is likely to occur.

For example, as shown in Steps S506 to S509 of FIG. 10, even when the measurement data transmitted from the transmitter 122 of the first field device 1 to the second field device 2 is not normally received by the second field device 2, the processing unit 23 of the second field device 2 performs the predetermined processing. In this case, since the previously received measurement data is stored in the receiving buffer 221, the processing unit 23 performs the predetermined processing on the basis of the previous measurement data, which is not up-to-date data. That is, the second field device does not perform desired processing.

The above-mentioned field devices have simple structures capable of performing only predetermined processing in order to reduce device costs, but cannot perform processing other than the predetermined processing. Therefore, there is a need to resolve the above-mentioned problems while keeping the structure of the field device simple.

### SUMMARY OF THE INVENTION

It is, therefore, a main object of the invention to provide an instrumentation control system utilizing a fieldbus communication method in which a field device, such as an actuator, reliably performs desired processing on the basis of measurement data transmitted from another field device, such as a measuring instrument.

According to one aspect of the present invention, there is provided an instrumentation control system, including: a first field device; and a second field device coupled to the first field device via a fieldbus to allow bidirectional communication, wherein the first field device includes: a transmitting buffer to store data to be transmitted to the second field device; a transmitter to transmit the data to the second field device; and an inquiry processing section to cause the transmitter to retransmit the data stored in the transmitting buffer to the second field device in response to a data retransmission request from the second field device, and the second field device includes: a receiving buffer to store the data transmitted from the first field device; a checking section to determine whether the data stored in the receiving buffer is normal or not, and to make a data retransmission request to the first field device if the data stored in the receiving buffer is not normal; and a processing unit to perform predetermined processing based on the data which is determined to be normal by the checking section.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 shows a schematic configuration of an exemplary network system in a plant;

FIG. 2 is a block diagram showing a schematic configuration of a first field device according to a first embodiment of the present invention;

FIG. 3 is a block diagram showing a schematic configuration of a second field device according to the first embodiment of the present invention;

FIG. 4 is a sequence chart illustrating sequence control in a field network system according to the first embodiment;

FIG. 5 is a block diagram showing a schematic configuration of a first field device according to a fifth embodiment of the present invention;

FIG. 6 is a block diagram showing a schematic configuration of a second field device according to the fifth embodiment;

FIG. 7 is a block diagram showing a schematic configuration of a first field device according to a sixth embodiment of the present invention;

FIG. 8 is a block diagram showing a schematic configuration of a conventional first field device as a measuring instrument;

FIG. 9 is a block diagram showing a schematic configuration of a conventional second field device as an actuator; and

FIG. 10 is a sequence chart illustrating sequence control in the conventional field network system.

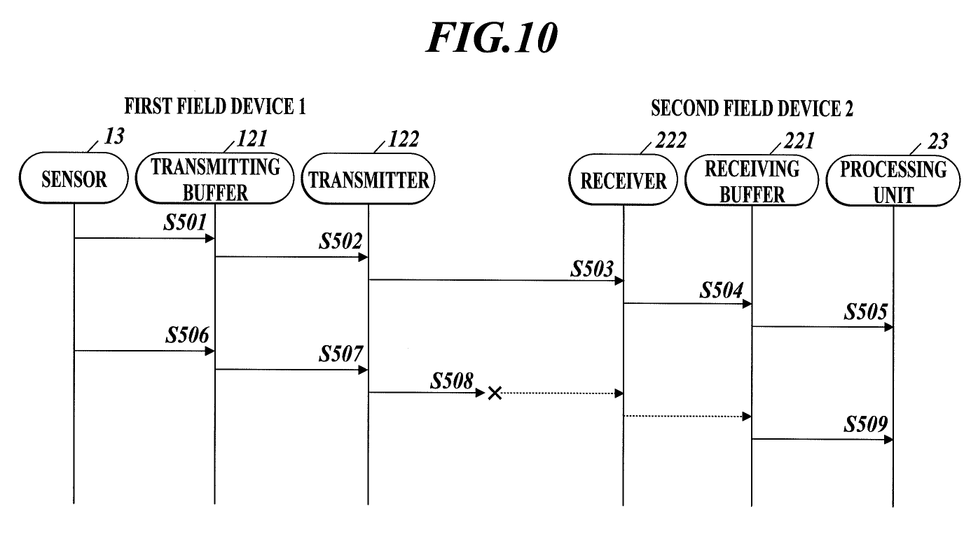

### DESCRIPTION OF THE PREFERRED EMBODIMENTS

Reference will now be made in detail to preferred embodiments of the present invention as illustrated in the accompanying drawings.

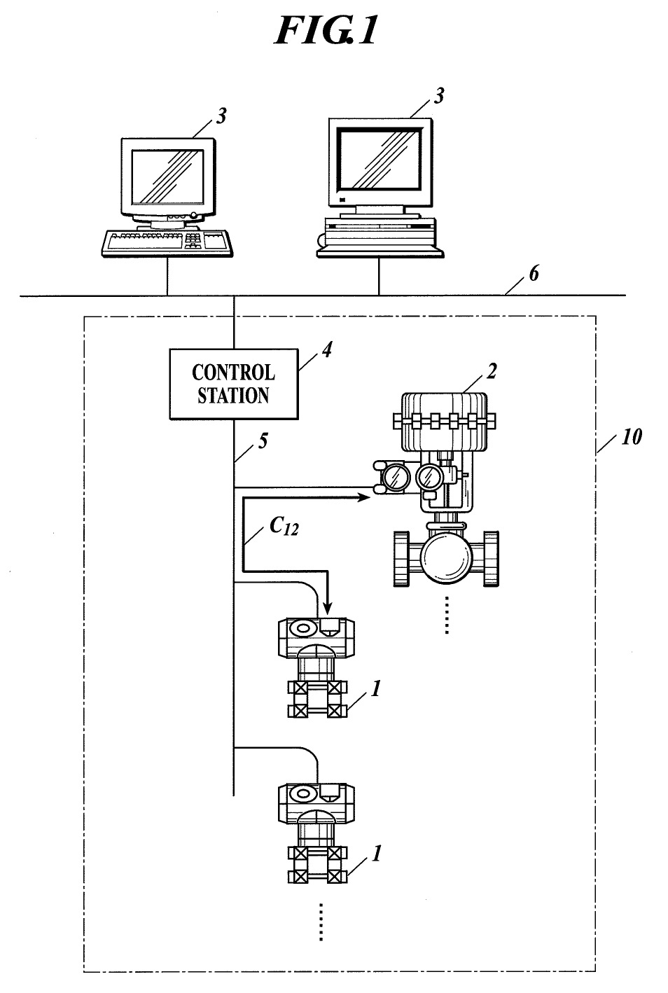

FIG. 1 shows a schematic configuration of an exemplary network system in a plant.

As shown in FIG. 1, a field network system 10 includes first field devices 1, 1, . . . , second field devices 2, . . . , consoles 3, 3, and a control station 4. The consoles 3 and the control station 4 are connected to each other by a control bus 6 such that they can communicate with each other. The control station 4 and the first field devices 1 are connected to each other via a fieldbus 5 such that they can communicate with each other. The control station 4 and the second field devices 2 are connected to each other via the fieldbus 5 such that they can communicate with each other. The first field devices 1 and the second field devices 2 are connected to each other via the fieldbus 5 such that they can communicate with each other. That is, the first field devices 1, the second field devices 2, and the control station 4 form the field network system 10.

The first field device 1 is, for example, a measuring instrument (sensor), such as a thermometer or a flow meter, and measures, for example, the temperature or the flow rate of various facilities in the plant.

The second field device 2 is, for example, an actuator (operation terminal), such as a motor, an electromagnet valve, a fan, a pump, or a valve, and adjusts the flow rate or the number of rotations of each facility in the plant, on the basis of measurement data obtained by the first field device 1.

The console 3 is an apparatus for monitoring the operational state of the plant. In general, a plurality of consoles are provided in each plant.

The control station 4 is an apparatus that controls the overall operation of the plant, and controls the second field devices 2 on the basis of the measurement data acquired by the first field devices 1.

In this embodiment, each of the second field devices 2 has a control function of controlling its own process, and can perform predetermined processing on the basis of the measurement data transmitted from the first field device 1. That is, the predetermined processing may be performed independently from the control of the control station 4. In this embodiment, for example, the predetermined processing means a process of adjusting a flow rate or the number of rotations.

Specifically, when the first field device 1 transmits measurement data to the second field device 2, the second field device 2 receives the measurement data, and performs predetermined processing on the basis of the received measurement data. In this embodiment, the invention is applied to data communication C₁₂ between the first field device 1 and the second field device 2.

### First Embodiment

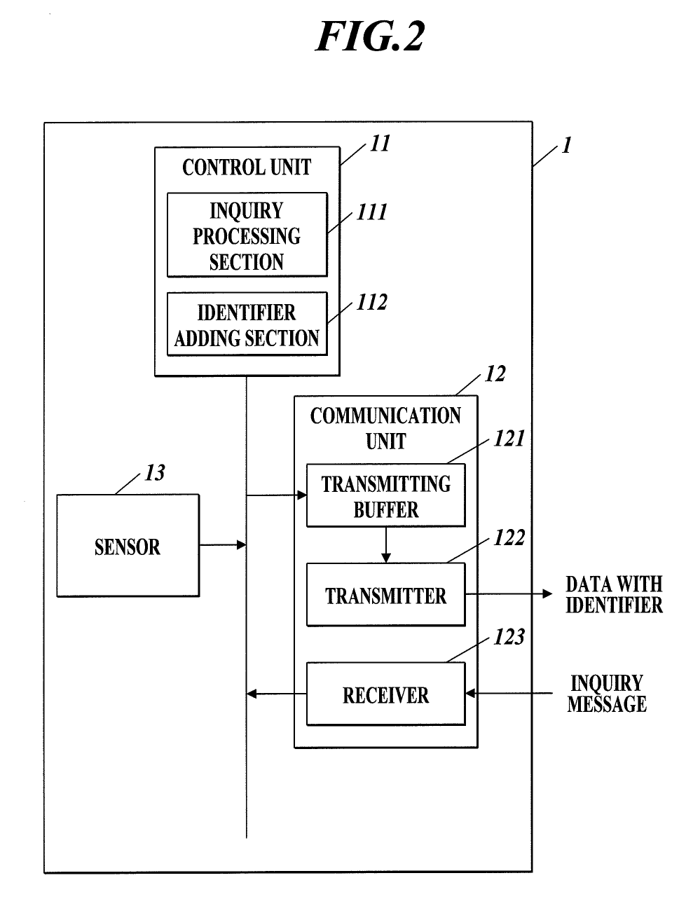

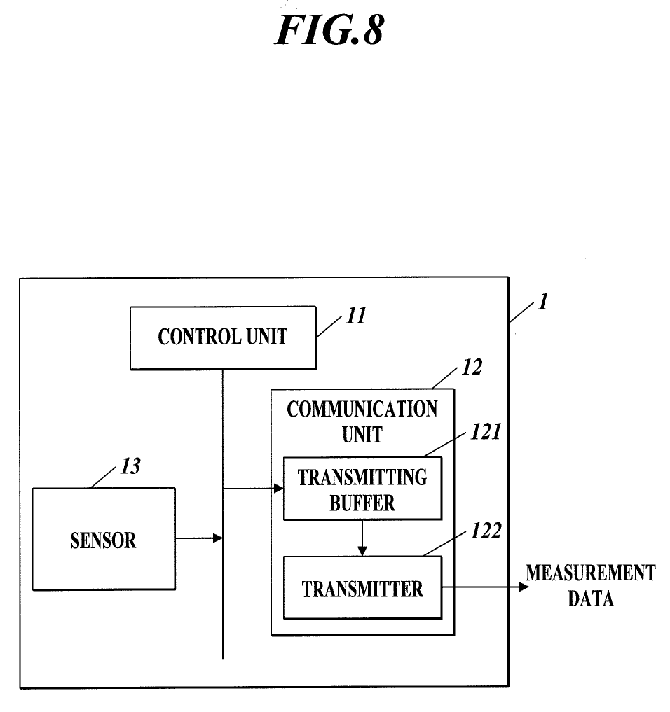

FIG. 2 is a block diagram showing a schematic configuration of a first field device (measuring instrument) 1 according to a first embodiment of the invention. In FIG. 2, the same reference numbers will be used to refer to the same elements as those of FIG. 8.

As shown in FIG. 2, the first field device 1 includes a control unit 11, a communication unit 12, and a sensor 13.

For example, the control unit 11 includes a CPU (central processing unit), a ROM (read only memory), and a RAM (random access memory), which are not shown in FIG. 2. The CPU loads various programs stored in the ROM into the RAM and executes the programs to perform overall control of each part.

The communication unit 12 includes a transmitting buffer 121 that temporarily stores measurement data, a transmitter 122 that periodically transmits the measurement data stored in the transmitting buffer 121 to the second field device 2, and a receiver 123 that receives a data retransmission request (inquiry message) transmitted from the second field device 2. The communication unit 12 performs data communication with the second field device 2 or the control station 4 connected thereto by the fieldbus 5 according to a predetermined communication protocol.

The sensor 13 periodically acquires various measurement data (for example, a flow rate). When the sensor 13 acquires measurement data, the communication unit 12 transmits the measurement data to the second field device 2.

In the first field device 1, the sensor 13 periodically acquires measurement data, and the measurement data is stored in the transmitting buffer 121. The transmitter 122 periodically acquires the measurement data stored in the transmitting buffer 121, and transmits the acquired measurement data to the second field device 2.

In the first embodiment, an identifier is added to the measurement data transmitted from the first field device 1 to the second field device 2 to discriminate the measurement data from other measurement data. For example, a sequence number (001, 002, 003, . . . ) indicating the order in which the measurement data is acquired is added as the identifier to the measurement data. That is, data (data with an identifier) transmitted to the second field device 2 includes measurement data, an identifier, and address information designating the second field device 2 as a destination. In addition, a unicast address indicating only a single interface or a multicast address indicating a predetermined group may be used as the address information.

The second field device 2 can determine whether measurement data to be used for processing is normal, on the basis of the identifier.

When the first field device 1 receives an inquiry message to require the retransmission of data from the second field device 2, it retransmits the measurement data to the second field device 2. In this case, the first field device transmits the measurement data with an identifier. The inquiry message is data that is transmitted from the second field device 2 to the first field device 1 when the second field device 2 does not receive measurement data that should be received.

The second field device 2 performs predetermined processing on the basis of the retransmitted measurement data.

That is, in the first field device 1, the control unit 11 includes an inquiry processing section 111 that causes data to be retransmitted in response to a data retransmission request from the second field device 2 and an identifier adding section 112 that adds an identifier to measurement data when transmitting the measurement data to the second field device 2.

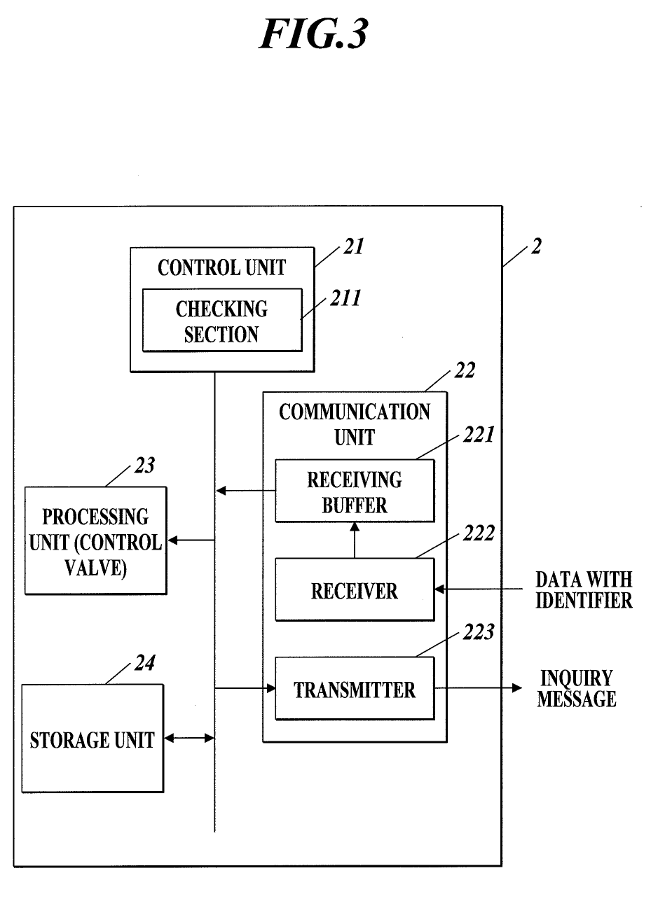

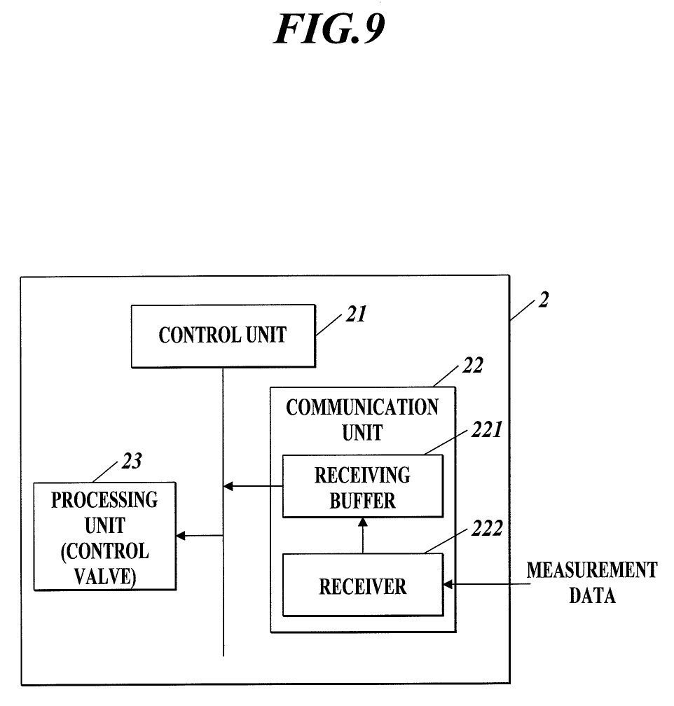

FIG. 3 is a block diagram showing a schematic configuration of a second field device (actuator) 2 according to the first embodiment. In FIG. 3, the same reference numbers will be used to refer to the same elements as those of FIG. 9.

As shown in FIG. 3, the second field device 2 includes a control unit 21, a communication unit 22, a processing unit 23, and a storage unit 24.

For example, the control unit 21 includes a CPU, a ROM, and a RAM, which are not shown in FIG. 3. The CPU loads various programs stored in the ROM into the RAM and executes the programs to perform overall control of each part.

The communication unit 22 includes a receiver 222 that receives data with an identifier transmitted from the first field device 1, a receiving buffer 221 that temporarily stores the data with an identifier received by the receiver 222, and a transmitter 223 that transmits an inquiry message to the first field device. The communication unit 22 performs data communication with the first field device 1 or the control station 4 connected thereto by the fieldbus 5 according to a predetermined communication protocol.

The processing unit 23 performs predetermined processing on the basis of the measurement data included in the data with an identifier that is stored in the receiving buffer 221. For example, if the second field device 2 is a valve controller that automatically adjusts a flow rate, the processing unit 23 opens or closes a control valve on the basis of the measurement data.

The storage unit 24 stores an identifier included in the data with an identifier that is received by the receiver 222. For example, when the processing unit 23 performs predetermined processing, an identifier added to the measurement data used for the process is stored in the storage unit 24. The identifier stored in the storage unit 24 is used to determine whether the measurement data included in the data with an identifier that is stored in the receiving buffer 221 is normal.

The term ‘normal measurement data’ means measurement data to be used for a process performed by the second field device 2, and is also measurement data for allowing the processing unit 23 to perform a desired process.

That is, when the first field device 1 periodically transmits measurement data, the transmitted measurement data allows the second field device 2 to perform a desired operation (normal measurement data). When the second field device 2 cannot receive the measurement data due to any cause, the measurement data that is previously received and stored in the receiving buffer 221 is used, and it is determined that the measurement data is not normal.

In the second field device 2, the receiver 222 receives the data with an identifier transmitted from the first field device 1, and the data with an identifier is stored in the receiving buffer 221. Since the first field device 1 periodically transmits the data with an identifier, the reception interval of data by the receiver 222 is generally substantially constant.

The processing unit 23 periodically acquires the measurement data included in the data with an identifier that is stored in the receiving buffer 221, and performs predetermined processing on the basis of the measurement data.

In the first embodiment, an identifier included in the data with an identifier that is stored in the receiving buffer 221 is used to determine whether the measurement data included in the data with an identifier (that is, measurement data used for a process) is normal. When a sequence number indicating the order in which the measurement data is acquired is used as the identifier, it is possible to easily determine whether the measurement data is normal.

When it is determined that the measurement data is not normal, the second field device transmits an inquiry message to require the retransmission of normal measurement data (measurement data that has not been normally received) to the first field device 1.

The first field device retransmits measurement data in response to the received inquiry message (the inquiry processing section 111).

That is, in the second field device 2, the control unit 21 includes a checking section 211 that determines whether the measurement data included in the data with an identifier that is stored in the receiving buffer 221 is normal or not. The checking section 211 requests the first field device 1 to retransmit data if the measurement data is not normal.

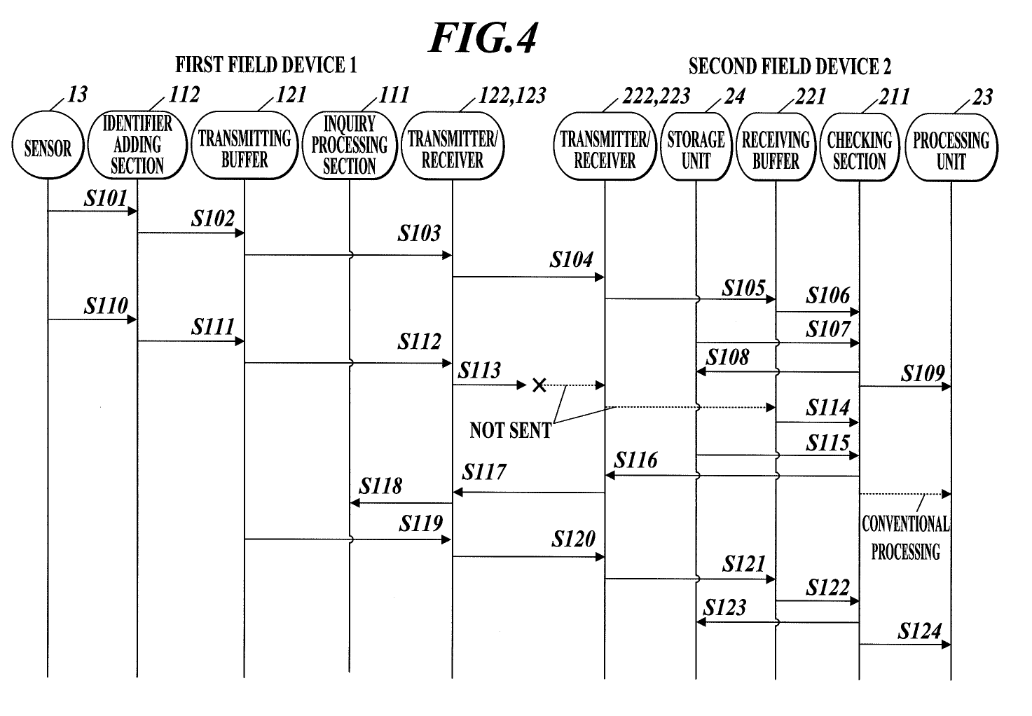

FIG. 4 is a sequence chart illustrating sequence control in the field network system according to the first embodiment.

In the first embodiment, suppose that the time at which the sensor 13 acquires measurement data and the time at which the transmitter 122 transmits data are set in advance. Similarly, suppose that the time at which the checking section 211 performs a confirmation process is set in advance. When the checking section 211 determines that the measurement data included in the data with an identifier that is stored in the receiving buffer 221 is normal, the measurement data is transmitted to the processing unit 23, and the processing unit 23 performs predetermined processing. Therefore, in general, the processing unit 23 also periodically performs predetermined processing.

In addition, suppose that a destination address (address information) of the data with an identifier transmitted from the first field device 1 is set to an address of the second field device 2 in advance. That is, the destination of data with an identifier transmitted from the first field device 1 is fixed to the second field device 2.

Suppose that a destination address of the inquiry message transmitted from the second field device 2 is set to an address of the first field device 1 in advance. That is, the destination of the inquiry message transmitted from the second field device 2 is fixed to the first field device 1.

FIG. 4 shows a control process when the second field device 2 normally receives the data with an identifier transmitted from the first field device 1 (Steps S101 to S109) and a control process when the second field device 2 does not normally receive the data with an identifier due to any cause (Steps S110 to S124).

As shown in FIG. 4, at the predetermined time to acquire measurement data, the sensor 13 acquires measurement data, and transmits the acquired measurement data to the identifier adding section 112 (control unit 11) (Steps S101 and S110).

The identifier adding section 112 adds a sequence number, serving as an identifier, to the received measurement data to create data with an identifier, and stores the data with an identifier in the transmitting buffer 121 (Steps S102 and S111). In addition, the identifier adding section 112 increases the sequence number and adds the increased sequence number as an identifier to the next measurement data.

At the predetermined time to transmit the data with an identifier to the second field device 2, the transmitter 122 acquires the data with an identifier from the transmitting buffer 121 (Steps S103 and S112), and transmits the acquired measurement data to the second field device 2 (Steps S104 and S113).

When the second field device 2 normally receives the data with an identifier transmitted from the first field device 1, the receiver 222 receives the data with an identifier transmitted from the first field device 1 (Step S104).

On the other hand, when the second field device 2 does not normally receive the data with an identifier transmitted from the first field device 1 due to any cause, the receiver 222 does not receive the data with an identifier transmitted from the first field device 1 (Step S113).

When the receiver 222 receives the data with an identifier, the received data is stored in the receiving buffer 221 (Step S105). In this case, the content of data stored in the receiving buffer 221 is updated with the latest one. When the receiver 222 does not receive data with an identifier, the content of the previous data stored in the receiving buffer 221 is used.

At the time at which the processing unit 23 performs predetermined processing, the checking section 211 (control unit 21) acquires the data with an identifier stored in the receiving buffer 221 (Steps S106 and S114).

The checking section 211 acquires the identifier (sequence number) stored in the storage unit 24, in order to determine whether the acquired data with an identifier is the latest data, that is, whether the measurement data included in the data with an identifier is normal measurement data to be used for a process (Steps S107 and S115). In this case, the sequence number added to the normal measurement data that has been used for the previous process is stored in the storage unit 24.

The checking section 211 compares the identifier (a first identifier (a first sequence number)) included in the data with an identifier that is stored in the receiving buffer 221 with the identifier (a second identifier (a second sequence number)) stored in the storage unit 24 to determine whether the measurement data with the first identifier (the measurement data included in the data with an identifier that is stored in the receiving buffer 221) is normal.

In the determining process, when the first sequence number included in the data with an identifier that is stored in the receiving buffer 221 is greater than the second sequence number stored in the storage unit 24, the data with an identifier stored in the receiving buffer 221 is the latest data that is newly received, and it is determined that the measurement data included in the data with an identifier is normal.

Then, the first sequence number added to the normal measurement data is stored in the storage unit 24 (Step S108). The first sequence number stored in the storage unit 24 is used as the second sequence number in the next determining process.

The normal measurement data is transmitted to the processing unit 23, and the processing unit 23 performs predetermined processing on the basis of the received normal measurement data (Step S109).

On the other hand, in the determining process, when the first sequence number is equal to the second sequence number, the data with an identifier stored in the receiving buffer 221 is not updated, that is, the receiver 222 receives no new data with an identifier. Therefore, it is determined that the measurement data included in the data with an identifier that is stored in the receiving buffer 221 is not normal.

In this case, the checking section 211 controls the transmitter 223 to transmit an inquiry message to require the retransmission of measurement data to the first field device 1 (Steps S116 and S117). The receiver 123 of the first field device 1 receives the inquiry message transmitted from the second field device 2 (Step S117).

The receiver 123 transfers the received inquiry message to the inquiry processing section 111 (Step S118). The inquiry processing section 111 causes the transmitter 122 to transmit the data with an identifier stored in the transmitting buffer 121, which is the same as that previously transmitted, in response to the inquiry message (data retransmission request) from the second field device 2 (Steps S119 and S120).

The receiver 222 of the second field device 2 receives the data with an identifier transmitted from the first field device 1 (Step S120).

When the receiver 222 receives the data with an identifier, the data is stored in the receiving buffer 221 (Step S121). The stored data with an identifier is automatically transmitted to the checking section 211.

When acquiring the data with an identifier, the checking section 211 stores an identifier (sequence number) included in the data with an identifier in the storage unit 24 (Step S123). That is, the data with an identifier that is automatically transmitted from the receiving buffer 221 is treated as data including normal measurement data.

In addition, the checking section 211 transmits the normal measurement data to the processing unit 23, and the processing unit 23 performs predetermined processing on the basis of the received normal measurement data (Step S124).

According to the field network system 10 of the first embodiment, the first field device 1, which is a transmitter side of measurement data, adds an identifier, such as a sequence number, to the measurement data. Then, the second field device 2, which is a receiver side of measurement data, compares the identifier (first sequence number) added to the measurement data to be used for a process with the identifier (second sequence number) added to the measurement data that has been used for the process to determine whether the data with an identifier transmitted from the first field device 1 is normally received. Thus, the second field device 2 can easily determine whether data is normally received (so-called data missing).

In addition, the second field device 2 can request the first field device to retransmit the latest measurement data. Then, the first field device 1 retransmits measurement data in response to the data retransmission request.

In the related art, when the first field device 1 transmits measurement data, the second field device 2 passively receives and acquires the measurement data. However, according to the first embodiment of the invention, the second field device 2 can actively acquire measurement data with the simplest structure.

In this way, even if the second field device 2 does not receive data with an identifier from the first field device 1 for any reason, the second field device actively requests the first field device to retransmit the data. Therefore, it is possible to complement measurement data to be used for a process.

Therefore, the second field device can reliably perform a desired process on the basis of the normal measurement data transmitted from the first field device. Therefore, it is possible to effectively prevent the occurrence of an unexpected error when predetermined processing is performed on the basis of the previous data.

In the first embodiment, the first field device 1 periodically acquires measurement data, and transmits the acquired measurement data to the second field device. Therefore, it is preferable to adjust the acquisition timing and the transmission timing of measurement data such that a data retransmitting process is completed before the first field device 1 performs a process of periodically transmitting the next measurement data (data with an identifier).

### Second Embodiment

In the first embodiment, the first field device 1 retransmits data with an identifier immediately after receiving an inquiry message. Therefore, the data retransmitting process does not satisfy the periodicity of a predetermined transmitting process of the first field device 1.

In the second field device 2, the periodicity of the receiving process of the receiver 22 is not synchronized with the periodicity of predetermined processing of the processing unit 23, which may cause errors.

For example, when the control unit 21 of the second field device 2 is used to control units other then the processing unit 23 on the basis of measurement data, it is difficult to keep the control unit ready to control the processing unit 23 on the basis of the retransmitted measurement data. In this case, the second field device is likely to receive no retransmitted data.

Therefore, in a second embodiment, when data with an identifier is retransmitted from the first field device 1 to the second field device 2 in the first embodiment, a transmission time can be specified.

In the second embodiment, the checking section 211 transmits an inquiry message including information specifying retransmission time in addition to the request for retransmitting data to the first field device 1. For example, the time at which the control unit 21 is in a standby mode in which it performs nothing is specified as the retransmission time.

When the first field device 1 receives the inquiry message with retransmission time, the inquiry processing section 111 retransmits data with an identifier at the specified retransmission time.

As such, in the second embodiment, the checking section 211 of the second field device 2 requests the first field device 1 to retransmit data and specifies the retransmission time of data. The inquiry processing section 111 of the first field device 1 causes the transmitter 122 to retransmit the data at the specified retransmission time.

Because the measurement data is retransmitted when the control unit 21 of the second field device 2 is in a standby mode, the control unit 21 can reliably perform a control process of receiving the measurement data, and reliably control the processing unit 23 on the basis of the received measurement data.

### Third Embodiment

In the first embodiment, the checking section 211 periodically determines whether the measurement data included in the data with an identifier that is stored in the receiving buffer 221 is normal, in synchronization with the period of predetermined processing of the processing unit 23. However, in some cases, the checking section continuously determines that the measurement data is not normal. For example, the transmission timing of the transmitter 122 of the first field device 1 and the reception timing of the receiver 222 of the second field device 2 may not be appropriately adjusted.

Therefore, in a third embodiment, even when no inquiry message is transmitted from the second field device 2, the first field device 1 retransmits data with an identifier.

In the third embodiment, the checking section 211 causes the transmitter 223 to transmit an inquiry message including information indicating that data with an identifier is to be periodically retransmitted from now on, in addition to the data retransmission request.

When the first field device 1 receives the inquiry message including that information, the inquiry processing section 111 causes the transmitter 122 to retransmit data with an identifier after the transmitter 122 transmits the data with an identifier at a set time.

According to the third embodiment, the checking section 211 of the second field device 2 requests the first field device 1 to retransmit data, and designates the next data to be retransmitted. Once the data retransmission request is received, the inquiry processing section 111 of the first field device 1 causes the transmitter 122 to transmit the subsequent data without the data retransmission request.

In this way, the first field device 1 periodically retransmits data in response to only one inquiry message to request the retransmission of data. Therefore, it is possible to reduce the load of the control unit 21.

This is effective as a temporary measure until the transmission timing of the transmitter 122 of the first field device 1 and the reception timing of the receiver 222 of the second field device 2 are appropriately adjusted.

### Fourth Embodiment

In the first embodiment, the first field device 1 retransmits the data with an identifier stored in the transmitting buffer 121 in response to the inquiry message (data retransmission request) transmitted from the second field device 2.

If the second field device 2 should perform the processing on the basis of measurement data with a high real-time property, the measurement data included in the retransmitted data with an identifier cannot have a real-time property in the first embodiment.

Therefore, in a fourth embodiment, the first field device 1 transmits measurement data reacquired by the sensor 13 to the second field device 2 in response to the inquiry message transmitted from the second field device 2.

In the third embodiment, the checking section 211 transmits an inquiry message including information (flag) indicating the type of required measurement data in addition to a data retransmission request to the first field device 1.

For example, when a flag in the inquiry message is “1”, the second field device requests the transmission of measurement data that is newly acquired by the sensor 13. When the flag is “0”, the second field device requests the transmission of data with an identifier stored in the transmitting buffer 121.

When the first field device 1 receives an inquiry message having a flag “1” added thereto, the inquiry processing section 111 instructs the sensor 13 to acquire measurement data. Then, an identifier is added to the measurement data that is newly acquired by the sensor 13 and the data is stored in the transmitting buffer 121. When the data with an identifier is stored in the transmitting buffer 121, the data is automatically transmitted to the second field device 2.

On the other hand, when the first field device 1 receives an inquiry message having a flag “0” added thereto, the inquiry processing section 111 causes the transmitter 122 to transmit the data with an identifier stored in the transmitting buffer 121 without any change.

According to the fourth embodiment, the inquiry processing section 111 of the first field device 1 causes the transmitting buffer 121 to store the measurement data that is newly acquired by the sensor 13 and causes the transmitter 122 to retransmit the measurement data, in response to the data retransmission request from the second field device 2.

In this way, for example, when the second field device 2 requires the real-time property of measurement data, it is possible to flexibly correspond to the requirements.

In the fourth embodiment, in general, the time required for the sensor 13 to newly acquire measurement data, add an identifier to the acquired data, and transmit the data is longer than the time required to transmit the data with an identifier stored in the transmitting buffer 121 without any change.

Therefore, it is preferable to combine the fourth embodiment with the second embodiment to specify the retransmission time of measurement data. In this way, the control unit 21 does not need to stand ready to control the receiver 222. Therefore, it is possible to effectively use the control unit 21 for other processes.

### Fifth Embodiment

In the first embodiment, the destination of the data with an identifier transmitted from the first field device 1 is consistently fixed to the second field device 2, and the destination of the inquiry message transmitted from the second field device 2 is consistently fixed to the first field device 1.

However, in addition to the first field device 1 and the second field device 2, many field devices are connected to the field network system 10. Therefore, in some cases, the first field device 1 receives a data retransmission request from field devices other than the second field device 2.

For example, when the same control process as described above is performed between other measuring instruments and actuators, the first field device 1 is likely to receive a data retransmission request from another field device, which is not a normal communication partner.

In addition, when the field network system 10 uses an IP, it is considered that the first field device 1 receives a data retransmission request by an unauthorized access from the outside.

In this case, there is a concern that, although the second field device 2 does not actually transmit a data retransmission request, the first field device 1 will retransmit data to the second field device 2 and the second field device 2 will perform an unexpected process.

When an unspecified number of field devices are connected to the field network system 10 or when an external device can access the field network system 10, it is necessary to reinforce security.

Therefore, in the fifth embodiment, an authentication function is added to communication between the first field device 1 and the second field device 2 such that data is transmitted in response to a data retransmission request from only the registered field devices.

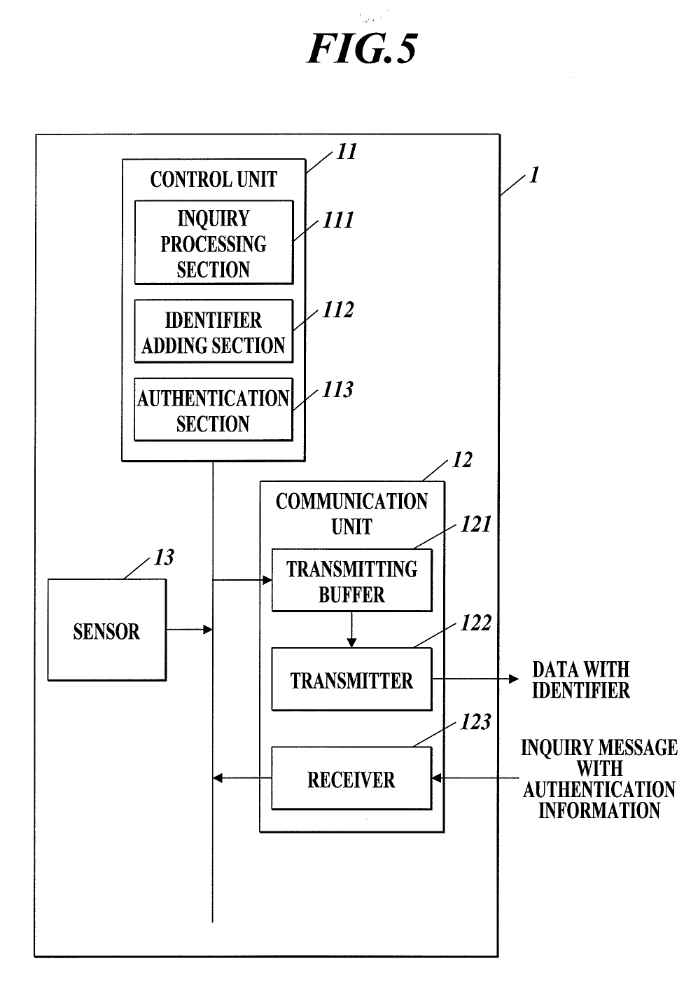

FIG. 5 is a block diagram showing a schematic configuration of a first field device 1 according to the fifth embodiment of the present invention. In FIG. 5, the same reference numbers will be used to refer to the same elements as those of the first embodiment shown in FIG. 2.

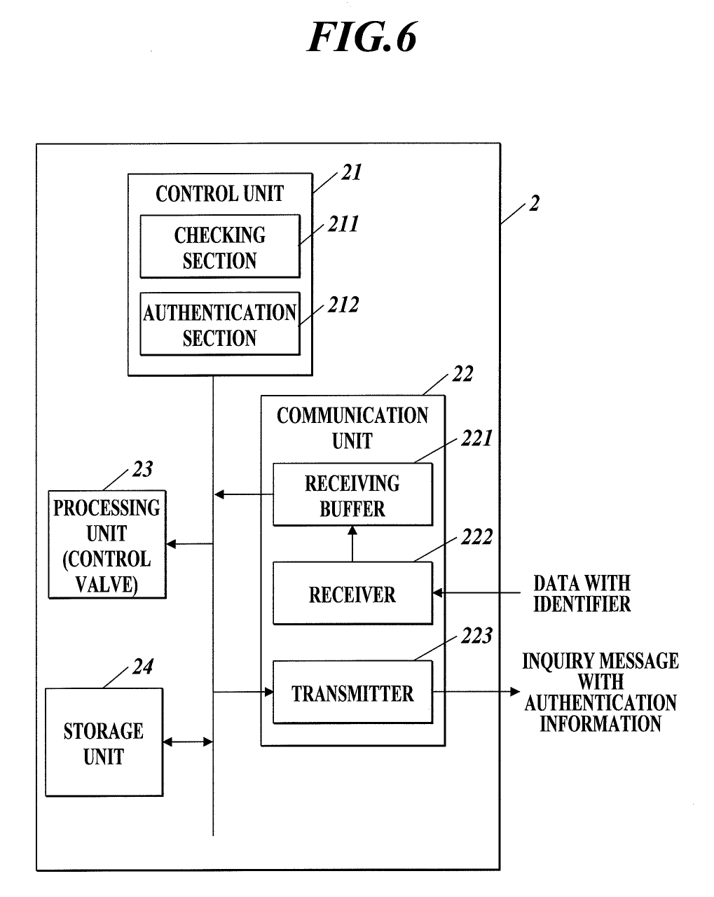

FIG. 6 is a block diagram showing a schematic configuration of a second field device 2 according to the fifth embodiment. In FIG. 6, the same reference numbers will be used to refer to the same elements as those of the first embodiment shown in FIG. 3.

As shown in FIG. 5, a control unit 11 includes an authentication section 113 that determines whether an inquiry message received by a receiver 123 is transmitted from the second field device 2 which is a destination device of the first field device 1.

In addition, as shown in FIG. 6, a control unit 21 includes an authentication section 212 that adds authentication information indicating that the inquiry message is transmitted from the second field device 2, to the inquiry message to be transmitted by the transmitter 223.

Each of the authentication section 113 and the authentication section 212 has, for example, key information for authentication and address information of the second field device 2 or the first field device 1, which is an authenticated communication party. The key information and the address information are stored in the ROMs (not shown) of the control units 11 and 21.

That is, the second field device 2 is registered as a communication partner in the first field device 1, and the first field device 1 is registered as a communication partner in the second field device 2.

In the second field device 2, when the checking section 211 transmits an inquiry message to the first field device 1, the authentication section 212 adds authentication information (key information and address information) to the inquiry message. Then, the transmitter 223 transmits the inquiry message with authentication information.

In the first field device 1, when the receiver 123 receives the inquiry message with authentication information, the inquiry processing section 111 inquires the authentication section 212 whether the inquiry message is transmitted from the second field device, which is a registered communication partner.

The authentication section 212 checks whether the field device is a registered field device on the basis of the authentication information (key information and destination address information) included in the inquiry message. If the inquiry message is transmitted from the registered field device, the inquiry processing section 111 causes the transmitter 122 to retransmit the requested data (data with an identifier). On the other hand, if the inquiry message is transmitted from an unregistered field device, the inquiry message is discarded.

According to the fifth embodiment, the checking section 211 of the second field device 2 makes a data retransmission request with authentication information indicating that the second field device 2 requests the retransmission of data. The inquiry processing section 111 of the first field device 1 causes the transmitter 122 to retransmit the data when it is authenticated that the data retransmission request is transmitted from the second field device on the basis of the authentication information included in the inquiry message.

Therefore, it is possible to prevent the first field device 1 from retransmitting data to the second field device 2 by mistake in response to a data retransmission request from an unauthorized external device. Therefore, it is possible to prevent the second field device 2 from performing an unexpected process.

The above-mentioned authentication method is generally known as a pre-shared key method. However, other authentication methods maybe used. In this case, it is also possible to obtain the same effects as described above.

In addition, when data with an identifier is transmitted from the first field device 1 to the second field device 2, authentication information may be added to the data. In this case, the second field device 2 may determine whether the data transmitted from the first field device 1 is normal. Therefore, it is possible to further improve security.

### Sixth Embodiment

In the first to fifth embodiments, the processing unit 23 of the second field device 2 performs a process in real time on the basis of the measurement data. However, the measurement data may be accumulated, and the accumulated data may be used for, for example, a management process.

Therefore, in a sixth embodiment, among data transmitted from the first field device 1 to the second field device 2, data that has not been normally received by the second field device 2 can be acquired from the previously received data.

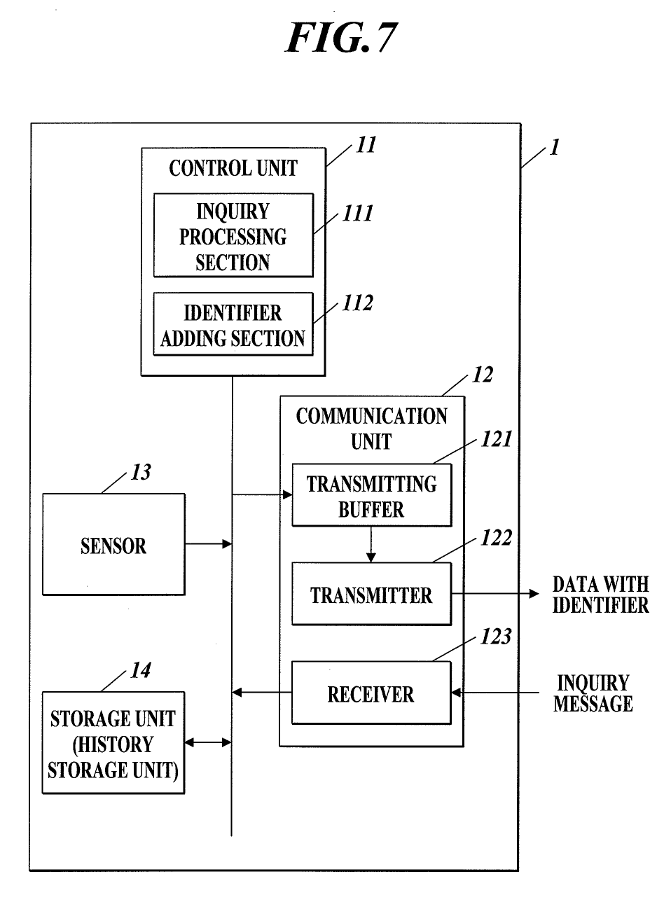

FIG. 7 is a block diagram showing a schematic configuration of a first field device 1 according to the sixth embodiment. In FIG. 7, the same reference numbers will be used to refer to the same elements as those of the first embodiment shown in FIG. 2.

As shown in FIG. 7, the first field device 1 includes a storage unit 14 (first history storage unit) that stores the history of data transmitted to the second field device 2. Data with an identifier actually transmitted to the second field device 2 is stored as a transmission history in the storage unit 14.

The configuration of the second field device 2 is the same as that in the first embodiment (see FIG. 3). In the sixth embodiment, a storage unit 24 (second history storage unit) stores measurement data in addition to an identifier for identifying normal measurement data. That is, data with an identifier actually received by the second field device 2 is stored in the storage unit 24.

The checking section 211 can specify missing data that has not been received with reference to the history stored in the storage unit 24.

When the second field device 2 needs to acquire the previous measurement data, the checking section 211 transmits, to the first field device 1, an inquiry message to which an identifier of desired measurement data (for example, a sequence number missed in the storage unit 24) is added.

In the first field device 1, when the receiver 123 receives the inquiry message, the inquiry processing section 111 acquires data with an identifier (it may acquire only the measurement data) corresponding to the identifier (sequence number) included in the inquiry message from the storage unit 14, and transmits the acquired data to the second field device 2.

In the sixth embodiment, the checking section 211 of the second field device 2 specifies missing data with reference to the history stored in the storage unit 24, and requests the first field device 1 to retransmit the missing data. The inquiry processing section 111 of the first field device 1 causes the transmitter 122 to transmit data stored in the storage unit 14 in response to the request.

With this, the second field device 2 can acquire the latest data for a process requiring a real-time property, and can also acquire the previous missing data. For example, this embodiment is effective in performing a management process on the basis of the accumulated measurement data.

In the sixth embodiment, the missing data is specified on the basis of the sequence number with reference to the history stored in the storage unit 24. When data communication is periodically performed, the reception time of data may be stored, and it is possible to specify missing data using the stored reception time of data.

As described above, according to the embodiments of the invention, when measurement data is transmitted from the first field device 1 to the second field device 2, the second field device 2 reliably and stably receives the measurement data. Therefore, it is possible to solve the problems arising when the field network system 10 uses an IP (for example, data missing or low security).

Although the exemplary embodiments of the invention have been described in detail above, the invention is not limited to the exemplary embodiments. Various modifications and changes of the invention can be made without departing from the scope of the invention.

In the embodiments, the first field device 1 is in one-to-one correspondence with the second field device 2. However, the second field device may correspond to a plurality of first field devices.

For example, when a plurality of first field devices 1, 1, . . . are connected to one second field device 2 such that they can communicate with each other, both an identifier included in the received data with an identifier and the address information of the first field device, which is a transmission source, are stored in the storage unit 24. When an inquiry message is transmitted, a desired first field device (a first field device that does not receive the transmitted data with an identifier) 1 may be set as a destination on the basis of the address information.

The first field device 1, which is a communication partner of the second field device 2, is not limited to a measuring instrument, but a field device that provides data for allowing the second field device 2 to perform predetermined processing may be used as the first field device. For example, a field device that analyzes the measurement data obtained by a measuring instrument and provides control data to the second field device 2 (the control station of FIG. 1) may be used as the first field device according to the invention.

It is understood that the foregoing detailed description is exemplary and explanatory only and is not restrictive of the invention, as claimed. It is intended that the present invention cover modifications and variations that come within the scope of the appended claims and their equivalents.

According to one aspect of the preferred embodiments of the present invention, there is provided an instrumentation control system, including: a first field device; and a second field device coupled to the first field device via a fieldbus to allow bidirectional communication, wherein the first field device includes: a transmitting buffer to store data to be transmitted to the second field device; a transmitter to transmit the data to the second field device; and an inquiry processing section to cause the transmitter to retransmit the data stored in the transmitting buffer to the second field device in response to a data retransmission request from the second field device, and the second field device includes: a receiving buffer to store the data transmitted from the first field device; a checking section to determine whether the data stored in the receiving buffer is normal or not, and to make a data retransmission request to the first field device if the data stored in the receiving buffer is not normal; and a processing unit to perform predetermined processing based on the data which is determined to be normal by the checking section.

With this structure, in the instrumentation control system (field network system) using a fieldbus communication method, the second field device (actuator) requests the data retransmission when data for performing the predetermined processing is not normal. Then, the first field device (measuring instrument) retransmits the data in response to the data retransmission request.

Because the second field device reliably performs desired processing on the basis of normal data transmitted from the first field device, it is possible to effectively prevent the second field device from performing the predetermined processing on the basis of the previous data.

Preferably, the transmitter of the first field device periodically transmits the data stored in the transmitting buffer to the second field device, and the processing unit of the second field device periodically performs the predetermined processing based on the data transmitted from the first field device.

Preferably, the first field device further comprises an identifier adding section to add an identifier for discriminating from other data, to the data to be transmitted to the second field device, the transmitter transmits the data with the identifier to the second field device, the receiving buffer of the second field device stores the data with the identifier transmitted from the transmitter, the identifier being a first identifier, the second field device further comprises a storage unit to store an identifier as a second identifier that is added to the data which is determined to be normal by the checking section, the checking section compares the first identifier included in the data with the identifier stored in the receiving buffer, with the second identifier stored in the storage unit to determine whether the data with the first identifier is normal or not.

Preferably, the checking section requests the first field device to retransmit data and specifies retransmission time of the data, and the inquiry processing section causes the transmitter to retransmit the data at the retransmission time.

Preferably, the checking section makes a data retransmission request to the first field device and gives the first field device an instruction to retransmit subsequent data to be transmitted, and the inquiry processing section causes the transmitter to retransmit the subsequent data without the data retransmission request once the instruction to retransmit the subsequent data is received.

Preferably, the checking section makes a data retransmission request with authentication information indicating that the data retransmission is requested from the second field device, and the inquiry processing section causes the transmitter to retransmit the data to the second field device when the data retransmission request from the second field device is authenticated based on the authentication information.

Preferably, the first field device further comprises a sensor to acquire measurement data, the transmitter transmits the measurement data to the second field device, and the processing unit of the second field device performs the predetermined processing based on the measurement data which is determined to be normal by the checking section.

Preferably, the inquiry processing section causes the transmitting buffer to store measurement data newly acquired by the sensor and causes the transmitter to retransmit the measurement data, in response to the data retransmission request from the second field device.

Preferably, the first field device comprises a first history storage unit to store a history of data transmitted to the second field device, the second field device comprises a second history storage unit to store a history of data which is determined to be normal by the checking section, the checking section specifies missing data with reference to the history stored in the second history storage unit, and makes a retransmission request of the missing data to the first field device, and the inquiry processing section causes the transmitter to transmit data stored in the first history storage unit in response to the retransmission request.

The entire disclosure of Japanese Patent Application No. 2008-127899 filed on May 15, 2008 including description, claims, drawings, and abstract are incorporated herein by reference in its entirety.

What is claimed is:

1. An instrumentation control system, comprising:
a first field device; and
a second field device coupled to the first field device via a fieldbus to allow bidirectional communication, wherein the first field device comprises:
a transmitting buffer to store data to be transmitted to the second field device;
a transmitter to transmit the data to the second field device; and
an inquiry processing section to cause the transmitter to retransmit the data stored in the transmitting buffer to the second field device in response to a data retransmission request from the second field device, and the second field device comprises:
a receiving buffer to store the data transmitted from the first field device;
a checking section to determine whether the data stored in the receiving buffer is normal or not, and to make a data retransmission request to the first field device if the data stored in the receiving buffer is not normal; and
a processing unit to perform predetermined processing based on the data which is determined to be normal by the checking section.

2. The instrumentation control system according to claim 1, wherein
the transmitter of the first field device periodically transmits the data stored in the transmitting buffer to the second field device, and
the processing unit of the second field device periodically performs the predetermined processing based on the data transmitted from the first field device.

3. The instrumentation control system according to claim 1, wherein
the first field device further comprises an identifier adding section to add an identifier for discriminating from other data, to the data to be transmitted to the second field device,
the transmitter transmits the data with the identifier to the second field device,
the receiving buffer of the second field device stores the data with the identifier transmitted from the transmitter, the identifier being a first identifier,
the second field device further comprises a storage unit to store an identifier as a second identifier that is added to the data which is determined to be normal by the checking section, and
the checking section compares the first identifier included in the data with the identifier stored in the receiving buffer, with the second identifier stored in the storage unit to determine whether the data with the first identifier is normal or not.

4. The instrumentation control system according to claim 1, wherein
the checking section requests the first field device to retransmit data and specifies retransmission time of the data, and
the inquiry processing section causes the transmitter to retransmit the data at the retransmission time.

5. The instrumentation control system according to claim 1, wherein
the checking section makes a data retransmission request to the first field device and gives the first field device an instruction to retransmit subsequent data to be transmitted, and
the inquiry processing section causes the transmitter to retransmit the subsequent data without the data retransmission request once the instruction to retransmit the subsequent data is received.

6. The instrumentation control system according to claim 1, wherein
the checking section makes a data retransmission request with authentication information indicating that the data retransmission is requested from the second field device, and
the inquiry processing section causes the transmitter to retransmit the data to the second field device when the data retransmission request from the second field device is authenticated based on the authentication information.

7. The instrumentation control system according to claim 1, wherein
the first field device further comprises a sensor to acquire measurement data,
the transmitter transmits the measurement data to the second field device, and
the processing unit of the second field device performs the predetermined processing based on the measurement data which is determined to be normal by the checking section.

8. The instrumentation control system according to claim 7, wherein
the inquiry processing section causes the transmitting buffer to store measurement data newly acquired by the sensor and causes the transmitter to retransmit the measurement data, in response to the data retransmission request from the second field device.

9. The instrumentation control system according to claim 1, wherein
the first field device comprises a first history storage unit to store a history of data transmitted to the second field device,
the second field device comprises a second history storage unit to store a history of data which is determined to be normal by the checking section,
the checking section specifies missing data with reference to the history stored in the second history storage unit, and makes a retransmission request of the missing data to the first field device, and
the inquiry processing section causes the transmitter to transmit data stored in the first history storage unit in response to the retransmission request.
